(19) United States
(12) Patent Application Publication
(10) Pub. No.: US 2018/0189842 A1
(43) Pub. Date: Jul. 5, 2018

(54) METHOD FOR DETERMINING MONETARY USER VALUE OF WEB ACTIVITY OF AN INDIVIDUAL USER, A USER DEVICE, A NETWORK ELEMENT AND COMPUTER PROGRAM PRODUCTS

(71) Applicant: TELEFONICA DIGITAL ESPANA, S.L.U., Madrid (ES)

(72) Inventors: Nicolas KOURTELLIS, Madrid (ES); Nikolaos LAOUTARIS, Madrid (ES)

(73) Assignee: TELEFONICA DIGITAL ESPANA, S.L.U., Madrid (ES)

(21) Appl. No.: 15/395,754

(22) Filed: Dec. 30, 2016

(51) Int. Cl. G06Q 30/02; H04L 29/08

(52) U.S. Cl. CPC G06Q 30/0275; H04L 67/22

(57) ABSTRACT

The method comprises receiving web activity of an individual user from at least one user device and from at least one network; identifying, based on said received web activity, a first advertising-related activity from un-encrypted web resources; calculating a first monetary user value based on accumulated un-encrypted web activity logs characterized in that web activity; calculating a second monetary user value based on advertising-related activity from encrypted web resources; and calculating a final monetary user value by adding said first and second values from advertising-related activity.

### TECHNICAL FIELD

This disclosure generally relates to the field of advertisement. In particular, the present invention relates to a method, a user device, a network element and computer program products, for determining monetary user value of web activity of an individual user.

### BACKGROUND OF THE INVENTION

Programmatic advertising (or programmatic ad) buying was developed to be the next big step in online advertising and has indeed enjoyed a rapid and steady growth the last years. Unlike the traditional static advertising, programmatic ad does not rely on wide exposure models for its success: it does not aim to reach the maximum number of eyeballs, but instead, to reach the proper eyeballs.

Programmatic ad buying is running over the Real Time Bidding (RTB) protocol that enables participating entities to buy and sell advertisements on a per-impression basis through programmatic instantaneous auctions. Users benefit by receiving more relevant ads while brands benefit from higher conversion rates from viewers to customers.

To match user interests with offered products, the advertising ecosystem has devised various data collection methods based on cookies, software/hardware identifiers, or elaborate fingerprinting techniques (e.g. [2]). Not surprisingly, aggressive data collection has led to serious public concerns regarding the impact of programmatic RTB on user privacy rights. A huge public debate has been developing around the tradeoffs between innovation in advertising and marketing, and basic civil rights around privacy and personal data protection. Opinions about who gets to decide what the right tradeoff is, vary: some say the market must decide; some say that it is the legislators' responsibility; some say the end users should decide on their own.

The third option—user empowerment—is gaining ground and may indeed lead to important developments in the area, in combinations maybe with some of the other two. In its initial and rather crude version, user empowerment came in the form of ad-blockers. Ad blocking technology has led to an arms race with popular publishing websites that now employ blocker detection technology to re-direct users with installed ad blockers to the non-free version of a website. Progressively most parties realize that all-out blocking is not a viable solution since it is effectively killing advertising, and with it, free services on the Internet. This has led to the latest revamping of user empowerment in the form of personal information management systems (PIMS) for permitting users to decide how much (if any) of their personal data they are willing to trade with the advertising ecosystem in exchange for service, money, or both (e.g., digi.me, Handshake, Simonite, etc.). For users to effectively make use of PIMS, an important prerequisite is that they somehow become aware of their actual value for the advertisers, something that is currently totally unknown to them.

An RTB auction is a programmatic, instantaneous type of auction, where a publisher's advertising inventory is bought and sold on a per-impression basis. A typical transaction for an ad-slot begins with a user visiting a website. This triggers a bid request from the publisher to an ADX, usually including various pieces of user's data (e.g. browsing history, demographics, location, cookie-related info, etc.). Then multiple advertisers or Demand-Side Providers (DSPs) automatically submit their ads and their bids in CPM (i.e. cost per thousand impressions, typically in US dollars or euros, based on the market), in real time to the ADX. The impression goes to the highest bidder and its ad is served on the publisher's page. The notification (nurl) sent to the winning bidder includes the charged price and is tunneled through the user to ensure that the advertiser's ad was indeed rendered. Typical RTB auctions are completed within 100 ms.

The prices in nurls can be in cleartext or encrypted form. Apparently, cleartext prices captured at the user's device can be easily tallied to estimate one part of the overall user value. The remaining part is more difficult to obtain due to the 28-byte encryption scheme used in some RTB versions. Such encryption cannot be easily broken.

Past studies [1, 3] assumed that encrypted prices follow the same distribution as cleartext prices. Indeed, one may argue that the price encryption is to avoid tampering of reported prices, and thus encrypted prices probably follow the cleartext price distribution. However, we think that an encrypted price may also be a sign of a higher value that the DSP wants to hide, for several reasons: (i.e. aggressive retargeting because of user's previous incomplete purchases, targeting users with higher spending habits, or users with specialized needs (e.g., sensitive products, expensive drugs, etc.). Therefore, an encrypted price may be used to reduce transparency over the bidding strategies of the participating DSPs, and prevent an external observer from assessing a competitor DSP's bidding methods or ad-campaigns. Thus, some DSPs may assume the extra computation overhead to reduce data leakage to competitors for users they track. In either case, our methodology, as described next, handles encrypted prices separately and thus allows us to account for any potential difference in their distribution from cleartext prices.

In summary, the past works have not solved the issue of encrypted price notifications in the computation of the user cost from the RTB advertising.

New solutions are therefore needed to overcome this issue, simplifying and improving at the same time the computation of the user cost.

### REFERENCES

[1] L. Olejnik, M. Tran, and C. Castelluccia. Selling off user privacy at auction. In 21st Annual Network and Distributed System Security Symposium, NDSS, San Diego, Calif., USA, Feb. 23-26, 2014.
[2] S. Englehardt, D. Reisman, C. Eubank, P. Zimmerman, J. Mayer, A. Narayanan, and E. W. Felten. Cookies that give you away: The surveillance implications of web tracking. In Proceedings of the 24th International Conference on World Wide Web, WWW '15, pages 289-299, New York, N.Y., USA, 2015. ACM.
[3] L. Olejnik and C. Castelluccia. To bid or not to bid? measuring the value of privacy in rtb. http://lukaszolejnik.com/rtb2.pdf

### DESCRIPTION OF THE INVENTION

To that end, the present invention provides, according to a first aspect, a method for determining monetary user value of web activity of an individual user. The method comprises receiving web activity of an individual user from a user device and a network; identifying, based on said received web activity, a first advertising-related activity from un-encrypted web resources (e.g. plaintext or a cleartext); calculating a first monetary user value based on accumulated un-encrypted web activity logs characterized in that web activity; calculating a second monetary user value based on advertising-related activity from encrypted web resources; and calculating a final monetary user value by adding the first and second values from advertising-related activity.

In an embodiment, the received web activity is filtered to keep only real time bidding (RTB) related web resources.

In an embodiment, a set of parameters from said un-encrypted and encrypted web resources including user location, publisher, time of day, day of week, size of the advertising, Demand-Side Platform or Provider, and/or Advertising Exchange involved is further extracted.

Moreover, the set of parameters can be send to a network element, the network element further using them to perform online advertising campaigns.

In an embodiment, the web activity is received from multiple user devices and from multiple networks used by the individual user. The multiple user devices may comprise at least two of the following terminals: a mobile phone, a laptop, a PC, and/or a smartTV, and the multiple networks may comprise at least two of the following: a home WiFi network, a WiFi network of an establishment, a Ethernet WiFi network of the individual user, an Ethernet WiFi network of an establishment, a mobile network of a telecommunications provider of the individual user and/or a mobile network through which the individual connects while roaming.

According to this last embodiment, a different weight value is preferably assigned to each user device used. Then, the web activity performed over each network in the different user devices used is accumulated; thereby the final monetary user value is computed by the sum of the weights values of the different contributions from the different user devices used.

In some situations, it may occur that the user device may not be always online or may not always have battery to perform frequent computations of the final monetary value. Thus, in an embodiment, the calculated final monetary user value is updated depending on the received web activity and/or on power and network resources at the user device. The calculated final monetary user value may be also automatically updated every certain period of time.

In another embodiment, the calculated final monetary user value is updated upon detecting drop in the accuracy performance among last computed values.

According to a second aspect, embodiments of the present invention also provide a user device comprising at least one processor and at least one memory, said user device having installed therein a software configured to calculate a monetary user value according to the method of the first aspect.

According to a third embodiment, embodiments of the present invention also provide a network element comprising at least one processor and at least one memory, the processor being configured to receive a set of parameters including user location, publisher, time of day, day of week, size of the advertising, Demand-Side Platform or Provider, and/or Advertising Exchange involved extracted from said un-encrypted and encrypted web resources and to further use the received set of parameters to perform online advertising campaigns.

Other embodiments of the invention that are disclosed herein include software programs to perform the method embodiment steps and operations summarized above and disclosed in detail below. More particularly, a computer program product is one embodiment that has a computer-readable medium including computer program instructions encoded thereon that when executed on at least one processor in a computer system causes the processor to perform the operations indicated herein as embodiments of the invention.

Present invention simplifies the computation of the user cost by omitting the portion of advertisements shown to the user.

In addition, present invention allows for the user and network provider to compute a better user cost by taking into account multiple user devices and activity performed over multiple networks (mobile, WiFi, Ethernet, etc.).

Moreover, present invention allows for an adaptive update of the model at the user side, based on consumed resources and network availability, as well.

Present invention enables the user to assess how much is worth for the advertising ecosystem due to the data he shares with it, and negotiate services or payout.

### BRIEF DESCRIPTION OF THE DRAWINGS

The previous and other advantages and features will be more fully understood from the following detailed description of embodiments, with reference to the attached figures, which must be considered in an illustrative and non-limiting manner, in which:

FIGS. 1 and 2 depict two flowcharts of the proposed method for determining monetary user value of web activity of an individual user.

FIG. 3 schematically depicts another embodiment of the proposed method for determining monetary user value of web activity of an individual user.

### DETAILED DESCRIPTION OF THE INVENTION

The figures and the following description relate to example implementations by way of illustration only. It should be noted that from the following discussion, alternative implementations of the structures and methods disclosed herein will be readily recognized as viable alternatives that may be employed without departing from the scope of this disclosure.

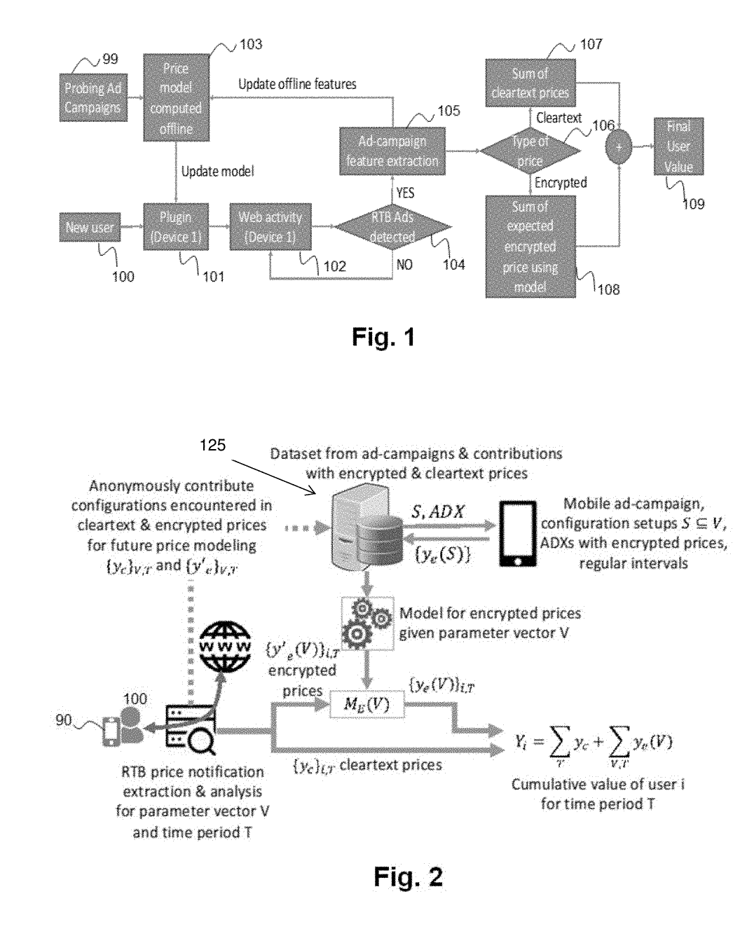

An object of present invention is to compute the cumulative ad value of a user 100 over a period of time while the user 100 browses the web from a single user device/terminal 90. In order to estimate a cumulative value Yᵢ for user i 100, while taking into account both values (encrypted and non-encrypted such as cleartext), the methodology illustrated in FIGS. 1 and 2 is proposed.

The user 100 first downloads and installs a plugin 101 into their user device 90 (e.g. a mobile device such as a Smartphone or a laptop). This plugin (a software) 101 is responsible for processing the web activity 102 of the user 100 in the current user device 90. If advertisements are detected that are of real-time-bidding nature 104, they will be processed to extract appropriate features used in ad-campaigns 105. These features can be sent to a network element 125 that is responsible for a) performing online ad-campaigns with these features to collect encrypted prices, b) computing a model for the encrypted prices collected. The model 103 can be also updated at certain time intervals on the user device 90.

Finally, the plugin 101 also computes a) the cleartext total user cost by summing all cleartext prices found 107, b) the expected encrypted total user cost 108 by summing all expected encrypted prices computed with the model 103. The final user cost 109 is the aggregation of the two partial results.

### RTB Ad Price Extraction:

From the user's 100 web activity 102 (weblogs) of a time period T, the proposed method extracts non-encrypted (e.g. cleartext) and encrypted charge price notifications of RTB-related ads. As mentioned earlier, the two types of price notification are handled differently. The detected nurls are also used for extracting a set of top parameters V 105 that could affect charge prices (e.g., user location, publisher, time of day, day of week, size of ad, DSP, ADX involved, etc.). These set of top parameters can be used to model prices in new ads, as explained next.

The cleartext prices 107 can be aggregated in a straightforward fashion, thus producing the ad value for user i 100 over such prices:

$${Yc}_{i} = {\sum }_{{{y}_{c} ∈ {Pc ( T )}_{ij}}_{j ∈ {Xc ( T )}_{i}}} {y}_{c}$$

where Xc(T)ᵢ is the set of ADXs sending cleartext price notifications to corresponding DSPs during T as found in user i's 100 weblogs 102, and Pc(T)ᵢⱼ is the set of cleartext price notifications for user i 100 and ADX jϵXc(T)ᵢ.

### Price Modeling Engine:

The vector V of different parameters, along with a sample of instances of encrypted {y′}ᵢ and cleartext {y_{c}}ᵢ prices of user i 100, can be anonymously contributed to a central repository, similarly to other works on data transparency in advertising (e.g., Floodwatch). This repository uses these price instances to train a machine learning model for inferring encrypted prices with the aid of “probing ad-campaigns”. This aggregated collection allows for more accurate modeling of prices, as data from multiple users and ad-campaigns served from various ADXs contribute better to the understanding of the important factors affecting RTB prices in different setups. The modeling of encrypted prices can be performed using standard machine learning approaches such as linear regression for computing an exact value, or random forests and support vector machines for computing a class (level) for the unknown value, given an instantiation of the parameter vector. The trained model Me(V) takes as input a vector of values for the parameters in V, and outputs the estimated value yₑ(V) of the encrypted price yₑ′(V):

yₑ(V)˜Mₑ(yₑ′(V))

### Probing Ad-Campaigns:

One way to obtain information on encrypted prices is to collaborate directly with an ADX that sends such prices. Here, however, the proposed method considers this to be the rare case, since ADXs are unwilling to share such data for free. Instead, the proposed method in an embodiment runs ad-campaigns through such ADXs and uses the returned reports to model encrypted prices.

These campaigns can be optimized to target the top ADXs sending encrypted prices with a specific set of experimental setups to cover all possible scenarios from the parameter vector V. Thus, they can be kept short and cheap. Given that the prices do not change drastically through time, these campaigns can be executed every few months to collect probing data for time-shift correction and increased coverage of more ADXs. Having such campaigns launched from a centralized location allows for more accurate and cost efficient price modeling that can be shared across all participating users in the same area or country. Furthermore, the campaigns can be crowdfunded (e.g. like Wikipedia), thus contributing to an independent and sustainable platform that can scale better across users, countries, and ADXs covered. ADXs could in principle fight back and try to identify and block such campaigns, but their huge clientele combined with the low volume of such campaigns make the detection very difficult.

Using the most important parameters extracted in vector V 105, the present invention constructs various experimental setups sϵS⊂V that can be used to deploy such ad-campaigns over a short period of time T′. These setups combine different values of control variables that are important for an ad-campaign such as location of the user 100, size of ad, time of day, day of the week. With the results of these campaigns (in essence, charged prices for RTB ads that fulfil a given setup s), the modeling engine can train a model 103 to estimate the value of new ads with a given setup s′˜sϵS. Note that S is a subset of V, that is, not all parameters in V needed to be used for the execution of probing ad-campaigns; only the most important ones.

### Inferring Encrypted Prices:

The encrypted prices for user i 100 can be characterized by the vector V extracted earlier. In order to infer their value, the proposed method in an embodiment uses the machine learning model Me(V) built by the engine and distributed to participating users. Given these estimated values yₑ(V)ᵢ, the aggregate value over encrypted prices for user i 100 can be computed:

$${Yc}_{i} = {\sum }_{{{y}_{c} ∈ {Pc ( T )}_{ij}}_{j ∈ {Xc ( T )}_{i}}} {y}_{c}$$

where Xe(T)ᵢ is the set of ADXs sending encrypted price notifications during T found in user i's 100 weblogs 102, and Pe(T)ᵢⱼ is the set of encrypted price notifications for user i 100 and ADXjϵXe(T)ᵢ.

### Total Cost:

The overall value of the user 100 for the time period T analyzed can be stated as:

$${Y}_{i} ( T ) = {Yc}_{i} ( T ) + {Ye}_{i} ( T ) \text{:}$$

$${Y}_{i} = {\sum }_{T} {y}_{c} + {\sum }_{{V}_{i} T} {y}_{e} ( V )$$

$$Cumulative value of user i for time period T$$

If a newly participating user would like to bootstrap their cumulative value from a longer past time period DT>T of historical data of users in the system, then an average cumulative value per user can be used, computed over multiple users' prices contributed to the platform (iϵU):

$$\overline{Y} = \frac{1}{\vert U \vert} {Σ}_{i ∈ U} {Y}_{i} ( DT )$$

### Evaluation of the Proposed Method:

### Data Input for Modeling:

To assess the feasibility and effectiveness of the proposed method, a year-long dataset D containing weblogs from volunteering mobile users was collected. The volunteers have agreed to use a controlled server as a proxy, thus allowing monitoring their outgoing HTTP traffic (no personally identifiable information was gathered or used and all data used were treated anonymously). As a result, the proposed method was able to collect a large dataset (Table 1) spanning the entire year of 2015.

TABLE 1
Summary of dataset and ad-campaigns.

| Metric | D | A1 | A2 |
|---|---|---|---|
| Time period | 12 months | 13 days | 8 days |
| Impressions | 78560 | 632667 | 318964 |
| RTB publishers | ~5.6k/month | ~0.2k | ~0.3k |
| IAB categories | 18 | 16 | 7 |
| Users | 1594 | — | — |

### RTB Price Extraction & Analysis:

To analyze the dataset, a HTTP Trace analyzer capable of detecting and extracting RTB-related traffic is implemented. To detect RTB nurls said tool applies pattern matching against a list of macros that were collected after (i) manual inspection and (ii) studying the existing RTB APIs (e.g., from companies like DoubleClick, MoPub, OpenX, PulsePoint, and the online Open RTB protocol used by the dominant advertising companies nowadays). This way, the present invention locates the price notifications of the existing RTB auctions in the dataset and extracts the charged prices (after filtering out any bidding prices that may co-exist in the nurl). Other operations carried out by the tool, include: (a) separation of mobile web browser and application originated traffic, (b) extraction of device-related attributes from the user-agent field (type of device, screen size, OS etc.), (c) creation of cooperating ADXs-DSPs pairs by leveraging the nurls were the ADX informs the bidder (i.e. the DSP) about its auction win, (d) extraction of the type of content a publisher may distribute in its website: the implemented tool relies on the online tagging service of Google AdWords, which is able to take as an input a domain and respond with a set of categories that match the type of content this domain is related with. This way, the present invention is able to link the type of content of each domain with the associated IAB category.

### Probing Ad-Campaigns:

In order to estimate the average cumulative value of the user 100 from the ad ecosystem using RTB price notifications, the proposed method takes into account the prices sent both in cleartext and encrypted form. The proposed method also considers how much these prices can change over time. One way to receive data about the prices of encrypted notifications is to collaborate directly with ADX or DSPs. This is not likely to occur however, since such companies guard carefully this information for a variety of reasons such as, confidentiality of contracts with customers, concerns about competitors, etc.

Instead, the present invention proposes another approach: run controlled ad-campaigns with specific ADXs just like an ordinary customer would do. Present invention had considered ADXs for encrypted prices such as DoubleClick, OpenX, RubiconProject and PulsePoint, as well as ADXs that send cleartext prices such as MoPub (the top mobile ADX). These ad-campaigns can be designed and executed with the help of a single or few DSPs any time with little overhead and a small budget of a few hundred euros each. Moreover, they can be blended with other real campaigns to make them more difficult to detect. Once designed, they can be automated and re-launched as frequently as needed, e.g., every few months or when the detected cleartext prices deviate from historical data.

The basic idea is to construct various experimental setups s E S that can be used to deploy an ad-campaign over these selected ADXs. These setups combine different values of control variables that are important for an ad-campaign:<user location, ad-size, device type, time of day, day of week, IAB of publisher>. For example, an experimental setup could be this: <NewYork, 320×50, smartphone, iOS, 12 am-9 am, Monday, IAB19>.

By running such controlled ad-campaigns, the proposed method can receive ground truth data about encrypted prices, thereby allowing training our classifier. Campaigns with ADXs that deliver cleartext prices also allow us to compare prices in different times and thus compute any shift in the price distribution due to time passed between the collection of a dataset D and present time.

The proposed method executed two rounds of ad-campaigns to collect data on prices. The first round (A1) was executed for 2 weeks in May 2016 and utilized the 4 ADXs mentioned earlier that encrypt price notifications and targeted publishers of many IAB categories. The second round (A2) was executed with the same experimental setups as A1 during June 2016, but in this case the DSP was instructed to use only MoPub, while still targeting similar IAB categories of publishers. In both campaigns, the DSP was given an upper bound on the bidding CPM price, to safeguard that they will not consume the allotted budget very quickly. On the other hand, the DSP was instructed to bid in a dynamic manner, as low or high as needed to get impressions delivered for the various experimental setups that were requested. Overall, the proposed method managed to receive over 600 k impressions displayed with encrypted price notifications to more than 200 publishers, and over 300 k impressions with cleartext price notifications to more than 300 publishers, targeting 6 IAB categories common to both price notification types.

Cost Paid Vs. IAB Category:

In order to examine more thoroughly how the different IAB categories affect the charge prices of the different RTB auctions, the proposed method takes a chunk of the dataset (spanning through a 2-month period) and, extracts the IAB categories for each publisher. To ensure the validity of the results and eliminate possible biases, the charge prices from only one advertising company were used, Mopub, which is the most popular owning 34% of the RTB ads in the dataset.

Next, the proposed method compares the overlapping IAB categories of the RTB impressions taking from (i) the 2 months Mopub dataset, (ii) the set of cleartext prices from the ad-campaign on MoPub (A2), (iii) the set of encrypted prices from A1. The results confirmed the following. First, cleartext prices have shifted (increased) over time between 2015 and 2016. Thus, the time-correction factor the current method proposes is indeed needed. Second, encrypted prices demonstrated different (larger) median distribution than cleartext prices, for the same IAB categories. Which confirms our intuition that encrypted prices are used to hide higher overall RTB prices.

### Price Modeling & User Value:

Using the data collected from the first ad-campaign for the various parameters, a machine learning classifier was trained to predict prices of encrypted notifications in RTB advertisements.

As a first step, the proposed method clustered the extracted encrypted prices into four classes, using an un-supervised equidistance model that finds the optimal splits between given prices using a method of leave-one-out estimate of the entropy of values in each class. The produced clusters were well balanced in a number of instances each. Next, a decision tree model with 10-fold cross validation was trained to predict the class of an encrypted price, based on the vector of parameters available. Decision trees were used because they can be trained quickly and have high accuracy and explainability. Using features such as city of user, day of week and the time the ad was delivered, ad size, mobile OS of the user's device, IAB category of the publisher, ADX used and device type, the classifier can achieve 82.3% accuracy and 0.96 of weighted area under the ROC curve (AUCROC). When the publisher used is also taken into account in the model, the performance of the classifier increases to 95% and 0.99 AUCROC. However, this is a classic overfit of the dataset and the proposed method should caution that the publishers used in the ad-campaigns are just a subset of the thousands of possible publishers that can be found in real weblogs. Therefore, the proposed method preferably uses the model 103 without the publisher as part of its input features. This model 103 was used next for the computation of the encrypted prices of RTB ads found in the weblogs 102 of each user 100, given the matching parameter values in V 105.

The classifier was used to estimate values for the encrypted prices of ads found in the weblogs 102 of each user. The proposed method also use the time-correction coefficient for the cleartext prices computed from the second ad-campaign which allows to take into account the increase in prices due to time difference from the time the weblogs 102 were collected (2015) and the ad-campaign execution (2016) (as mentioned earlier).

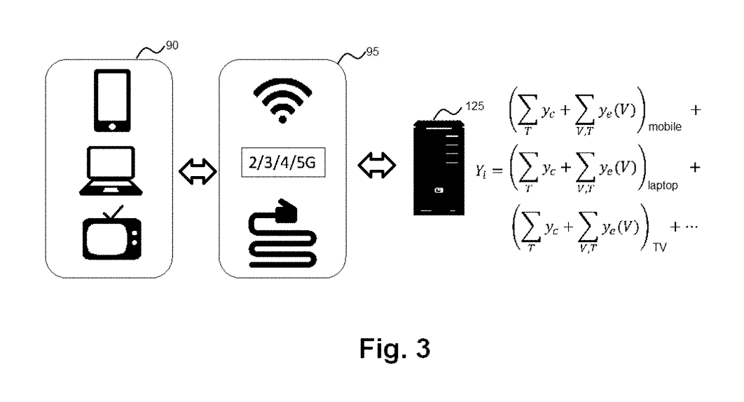

With reference now to FIG. 3, therein it is an embodiment of the proposed method to establish an overall score from different devices 90 and different networks 95. The method assigns a different weight value to each user device 90 used by the user 100 (e.g., a mobile device, a laptop, a TV, etc.) and also accumulates the web activity 102 performed over each network 95 (e.g., a mobile 4G network, a WiFi network, Ethernet, etc.). Thus, the final monetary user value in this case is computed by the sum of the weighted values of the different contributions from the different user devices 90 used.

The plugin 101 can be smart or dumb. That means, the plugin 101 can perform its own machine learning modeling and be updated less frequently from the network element 125. However, when the variability of the predicted prices increases a lot and the performance of the local model drops a lot, i.e. upon detecting drop in the accuracy performance among last computed values, the plugin 101 can request for an updated and more general model from the network element 125.

The modeling of the prices can be performed with batch-based machine learning methods or streaming learning methods. That means the model 103 may be learned using a batch of data at a time, or can be updated at “real time”, by creating a new model 103 for every new instance of data inputted.

The proposed invention may be implemented in hardware, software, firmware, or any combination thereof. If implemented in software, the functions may be stored on or encoded as one or more instructions or code on a computer-readable medium.

Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. Any processor and the storage medium may reside in an ASIC. The ASIC may reside in a user device. In the alternative, the processor and the storage medium may reside as discrete components in a user device.

As used herein, computer program products comprising computer-readable media including all forms of computer-readable medium except, to the extent that such media is deemed to be non-statutory, transitory propagating signals.

The scope of the present invention is defined in the following set of claims.

1. A method for determining monetary user value of web activity of an individual user, comprising:
receiving web activity of an individual user from at least one user device and from at least one network;
identifying, based on said received web activity, a first advertising-related activity from un-encrypted web resources;
calculating a first monetary user value based on accumulated un-encrypted web activity logs characterized in that web activity;
calculating a second monetary user value based on advertising-related activity from encrypted web resources; and
calculating a final monetary user value by adding said first and second values from advertising-related activity.

2. The method of claim 1, wherein said received web activity being filtered to keep only real time bidding (RTB) related web resources.

3. The method of claim 1, further comprising extracting a set of parameters from said un-encrypted and encrypted web resources including user location, publisher, time of day, day of week, size of the advertising, Demand-Side Platform or Provider, and/or Advertising Exchange involved.

4. The method of claim 3, further comprising sending the extracted set of parameters to a network element, the network element further using them to perform online advertising campaigns.

5. The method of claim 1, wherein the web activity being received from multiple user devices and from multiple networks used by the individual user, wherein the multiple user devices comprises at least two of the following: a mobile phone, a laptop, a PC, and/or a smartTV, and the multiple networks comprises at least two of the following: a home WiFi network, a WiFi network of an establishment, a Ethernet WiFi network of the individual user, an Ethernet WiFi network of an establishment, a mobile network of a telecommunications provider of the individual user and/or a mobile network through which the individual connects while roaming.

6. The method of claim 5, further comprising:
assigning a different weight value to each user device used; and
accumulating the web activity performed over each network in the different user devices used, thereby the final monetary user value being computed by the sum of the weighted values of the different contributions from the different user devices used.

7. The method of claim 1, wherein said un-encrypted web resources comprises a plaintext or a cleartext.

8. The method of claim 1, further comprising updating the calculated final monetary user value depending on the received web activity and/or on power and network resources at the user device.

9. The method of claim 1, further comprising automatically updating the calculated final monetary user value every certain period of time.

10. The method of claim 1, further comprising updating the calculated final monetary user value upon detecting drop in the accuracy performance among last computed values.

11. A user device comprising at least one processor and at least one memory, said user device having installed therein a software configured to calculate a monetary user value according to the method of claim 1.

12. A network element comprising at least one processor and at least one memory, said processor being configured to receive a set of parameters including user location, publisher, time of day, day of week, size of the advertising, Demand-Side Platform or Provider, and/or Advertising Exchange involved extracted from said un-encrypted and encrypted web resources and to further use the received set of parameters to perform online advertising campaigns.

13. A computer program product including code instructions that, when executed by at least one processor of a user device are configured to implement a method for determining monetary user value of web activity of an individual user, by:
receiving web activity of an individual user from said user device and from a network;
identifying, based on said received web activity, a first advertising-related activity from un-encrypted web resources;
calculating a first monetary user value based on accumulated un-encrypted web activity logs characterized in that web activity;
calculating a second monetary user value based on advertising-related activity from encrypted web resources; and
calculating a final monetary user value by adding said first and second values from advertising-related activity.

14. The computer program product of claim 13, wherein the code instructions are configured to filter said received web activity to keep only real time bidding (RTB) related web resources.

15. The computer program product of claim 13, wherein the code instructions are further configured to extract a set of parameters from said un-encrypted and encrypted web resources including user location, publisher, time of day, day of week, size of the advertising, Demand-Side Platform or Provider, and/or Advertising Exchange involved.

16. The computer program product of claim 14, wherein the code instructions are further configured to send the extracted set of parameters to a network element, the network element further using them to perform online advertising campaigns.
